(19) United States
(12) Patent Application Publication
(10) Pub. No.: US 2016/0173955 A1
(43) Pub. Date: Jun. 16, 2016

(54) METHOD AND SYSTEM FOR IMPLEMENTING A HYBRID BROADCAST UNICAST TELEVISION

(71) Applicant: VIDMIND LTD., Tel-Aviv (IL)

(72) Inventors: Ofer HERMAN, Ein-Sarid (IL); Dan Peled, Tel Aviv (IL)

(21) Appl. No.: 14/571,306

(22) Filed: Dec. 16, 2014

(51) Int. Cl. H04N 21/647; H04N 21/24

(52) U.S. Cl. CPC H04N 21/64707; H04N 21/64738; H04N 21/24

(57) ABSTRACT

A method of implementing a hybrid broadcast-unicast television is provided herein. The method may include: broadcasting a stream of a user-requested content over a digital television (DTV) channel; monitoring at least one qualitative criterion of the stream broadcasted over the DTV channel; in case that the monitored qualitative criterion is below a predefined threshold, switching said user to an internet protocol (IP) channel that corresponds to same stream of said DTV channel; and in a case that after switching to the IP channel, the monitored qualitative criterion becomes equal to or above said predefined threshold, switching back said user to said DTV channel, wherein the switching from the IP channel to the DTV channel comprises buffering the stream of the DTV channel through the IP channel so as to preserve continuity of the stream received by the user.

### FIELD OF THE INVENTION

The present invention relates generally to the field of multimedia networks, and more particularly to implementing a hybrid broadcast unicast television system.

### BACKGROUND OF THE INVENTION

Prior to the background of the invention being set forth, it may be helpful to set forth definitions of certain terms that will be used hereinafter.

The term “unicast transmission” or simply “unicast” as used herein is defined as the sending of messages to a single network destination identified by a unique address. A non-limiting example for a unique address is an Internet protocol (IP) address.

The term “broadcast transmission” or simply “broadcast” as used herein is defined as a method of transferring a message to all recipients simultaneously. Broadcasting may be performed as a high level operation in a program, for example broadcasting Message Passing Interface, or it may be a low level networking operation, for example broadcasting over the air.

The term “Digital television” (DTV) as used herein is defined as the transmission of audio and video by digitally processed and multiplexed signal, in contrast to the totally analog and channel separated signals used by analog television. Digital TV can support more than one program in the same channel bandwidth. Many countries are replacing broadcast analog television with digital television and allowing other uses of the television radio spectrum. Several regions of the world are in different stages of adaptation and are implementing different broadcasting standards. There are four different widely used digital television terrestrial broadcasting standards (DTTB): Terrestrial Integrated Services Digital Broadcasting (ISDB-T) is a system designed to provide good reception to fix receivers and also portable or mobile receivers. It utilizes OFDM and two-dimensional interleaving. It supports hierarchical transmission of up to three layers and uses MPEG-2 video and Advanced Audio Coding. ISDB-T International is an adaptation of this standard using H.264/MPEG-4 AVC; Digital Video Broadcasting-Terrestrial (DVB-T) uses coded orthogonal frequency-division multiplexing (OFDM) modulation and supports hierarchical transmission; Advanced Television System Committee (ATSC) uses eight-level vestigial sideband (8VSB) for terrestrial broadcasting; and Digital Terrestrial Multimedia Broadcasting (DTMB) adopts time-domain synchronous (TDS) OFDM technology with a pseudo-random signal frame to serve as the guard interval (GI) of the OFDM block and the training symbol.

The term “Internet television” or “online television” as used herein is defined as the digital distribution of television content via the Internet. Internet television is a general term that covers the delivery of television shows and other video content over the Internet by video streaming technology, typically by major traditional television broadcasters. It does not describe a technology used to deliver content.

One of the challenges that digital TV needs to address is to how to maintain the overall user experience—especially the quality of the video—at all times, even when reception is poor.

### SUMMARY OF THE INVENTION

Embodiments of the present invention provide a method of implementing a hybrid broadcast-unicast television. The method may include: broadcasting a stream of a user-requested content over a digital television (DTV) channel; monitoring at least one qualitative criterion of the stream broadcasted over the DTV channel; in case that the monitored qualitative criterion is below a predefined threshold, switching said user to an internet protocol (IP) channel that corresponds to same stream of said DTV channel; and in a case that after switching to the IP channel, the monitored qualitative criterion becomes equal to or above said predefined threshold, switching back said user to the DTV channel, wherein the switching from the IP channel to the DTV channel comprises buffering the stream of the DTV channel through the IP channel so as to preserve continuity of the stream received by the user.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an exemplary architecture on which embodiments of the present invention may be implemented;

FIG. 2 is a block diagram illustrating a non-limiting exemplary architecture of a device in accordance with embodiments of the present invention;

FIG. 3 is a flowchart diagram illustrating a method in accordance with embodiments of the present invention;

FIG. 4A is a timing diagram illustrating an aspect in accordance with embodiments of the present invention; and

FIG. 4B is a flowchart diagram illustrating an aspect of a method in accordance with embodiments of the present invention;

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

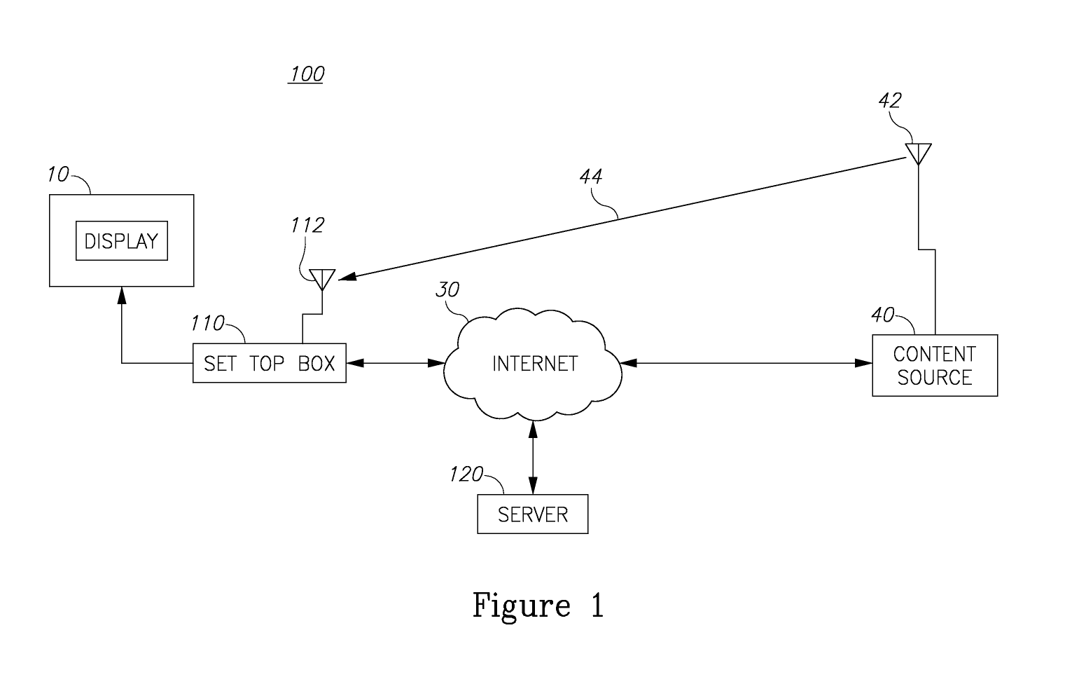

FIG. 1 is a block diagram illustrating an exemplary architecture on which embodiments of the present invention may be implemented. System 100 may include a digital television (DTV) content source 40 whose channel can be terrestrial or via a satellite DTV downlink channel 44 and transmitted via a transmission system 42. The DTV downlink channel 44 is received by reception device 112 (e.g. an antenna for DTT and a dish for SAT) of set-top box 110 which includes a DTV tuner (not shown here). Set-top box 110 may be connected to television (TV) 10 which is being watched and controlled by a user (not shown here). Additionally, set-top box 110 may be further connected to a server 120 via the Internet network 30. In operation, set-top box 110 monitors the signal quality of downlink DTV channel 44 and whenever the quality goes below a predefined threshold, downlink DTV channel 44 switches to an alternative IP channel originated by server 120. Server 120 generates IP streams identical to the content broadcasted over downlink DTV channel 44, by, for example, converting the DTV content from DTV source 40 into IP streams. The switching back from the IP channel to the broadcast transmission channel may include buffering the stream of the DTV channel on a local storage so as to preserve continuity of the stream received by the user. This is due the latency associated with IP streams which causes the IP stream to lag behind the DTV channel.

After switching to the IP channel, set-top box 110 keeps monitoring the signal quality of downlink DTV channel 44. In a case that the monitored qualitative criterion becomes equal to or above said predefined threshold, set top box 110 may be configured to switch back said user to said DTV channel.

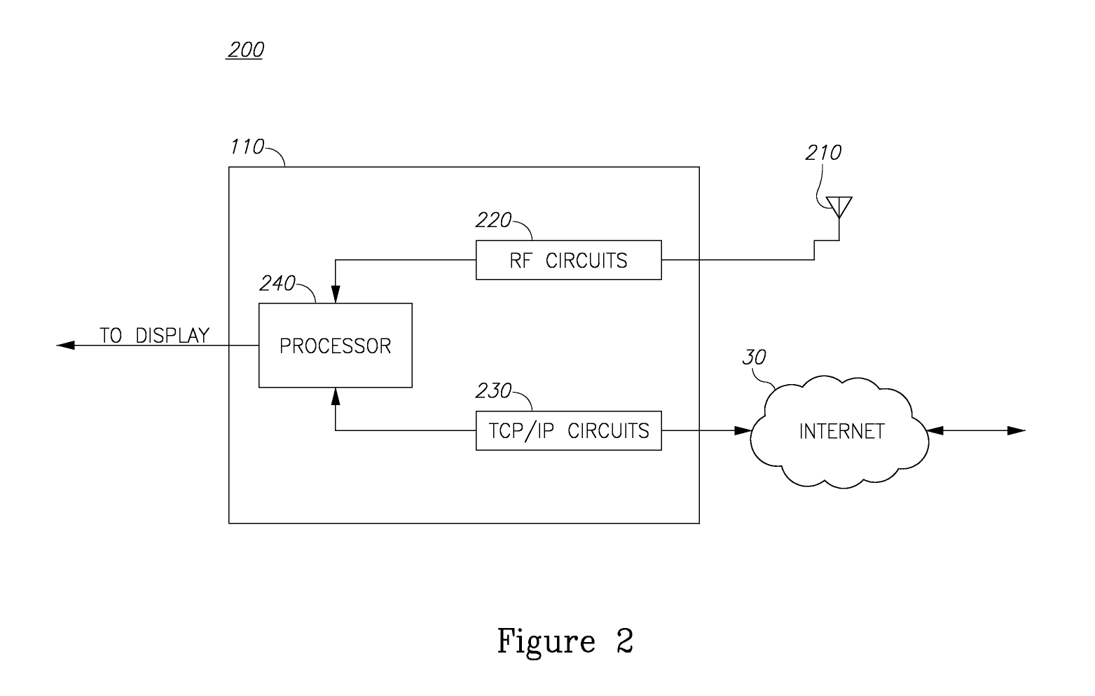

FIG. 2 is a block diagram illustrating a non-limiting exemplary architecture of a device in accordance with embodiments of the present invention. Set top box 200 may include a RF circuits (e.g. DTV tuner) 220 coupled to a reception device (e.g., antenna) 210. Set top box 200 may further include (TCP/IP circuits (e.g., an internet port) 230 connected to the Internet network 30 possibly via Wi-Fi connection. Both DTV tuner 220 and Internet network 30 may feed a computer processor configured to control them and further deliver the streamed multimedia content to the TV.

According to some embodiments of the present invention, the DTV channel may be associated with a digital terrestrial television system. Alternatively, it can be a satellite digital broadcast network.

According to some embodiments of the present invention, the monitoring of at least one qualitative criterion of the stream may include monitoring the received signal of the broadcasted stream, and/or the video quality received from the stream, and only if both are beyond an acceptable threshold, maintain the DTV stream.

According to some embodiments of the present invention, the switching of the user to an internet protocol (IP) channel may be carried out by providing switching data for matching between a source of the DTV channel and a source of the IP channel.

According to some embodiments of the present invention, the switching data is provided form a remote location independent of the DTV source and the IP source.

According to some embodiments of the present invention, the switching back from the IP channel to the DTV channel may include writing incoming content from the DTV channel into a cache while playing the steam from the IP channel until the stream reaches a program clock reference (PCR) already stored at said cache.

According to some embodiments of the present invention, the switching to the broadcast channel from the IP channel may further include checking whether a buffer time recorded by a buffer is equal or greater than a low reception time in which the monitored qualitative criterion is below a predefined threshold.

According to some embodiments of the present invention, in a case that buffer time may be equal to or greater than the low reception time, the set top box may be configured to display a buffering image to the user for a time that is approximately the difference between the buffer time and the low reception time.

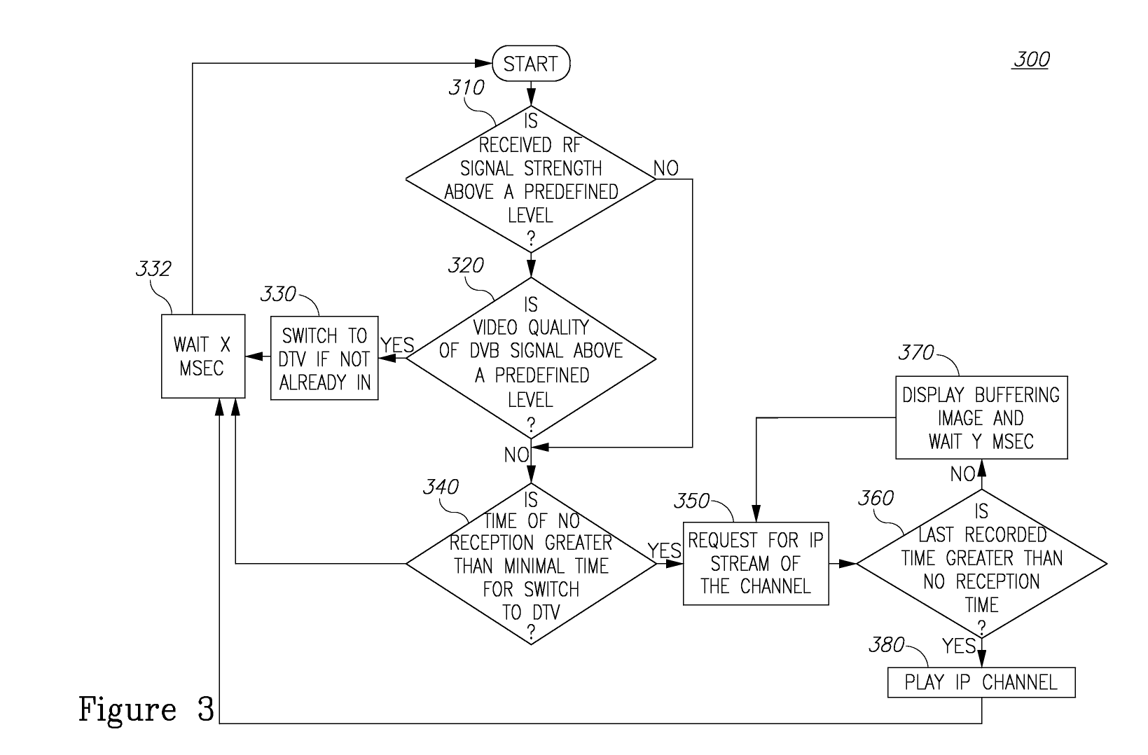

FIG. 3 is a flowchart diagram 300 illustrating an aspect of a method in accordance with embodiments of the present invention. The channel view is initiated by the user. Then, if the signal strength is lower than an acceptable level and the video quality is also lower than an acceptable level 310 320, the no (or weak) reception time is checked vs. the minimal time for switching to IP playing 340 in case the no reception time is indeed longer, a request for an IP stream on the channel is made 350. Then, the last recorded time is checked to be greater of or equal to the no reception time 360. In case it is, the IP channel is being played 380, X milliseconds are being waited 332 and again the signal level and video quality is being checked 310. In a case that the signal level and the video quality are not below an acceptable threshold, DTV channel is maintained 330, for at least X milliseconds 332 and then the signal level and video quality are being checked again 310, 320. In a case that the last recorded time is not greater of or equal to the no reception time, a buffering image is being displayed and Y milliseconds are being waited 370 before another request for IP stream of the channel is made again 350.

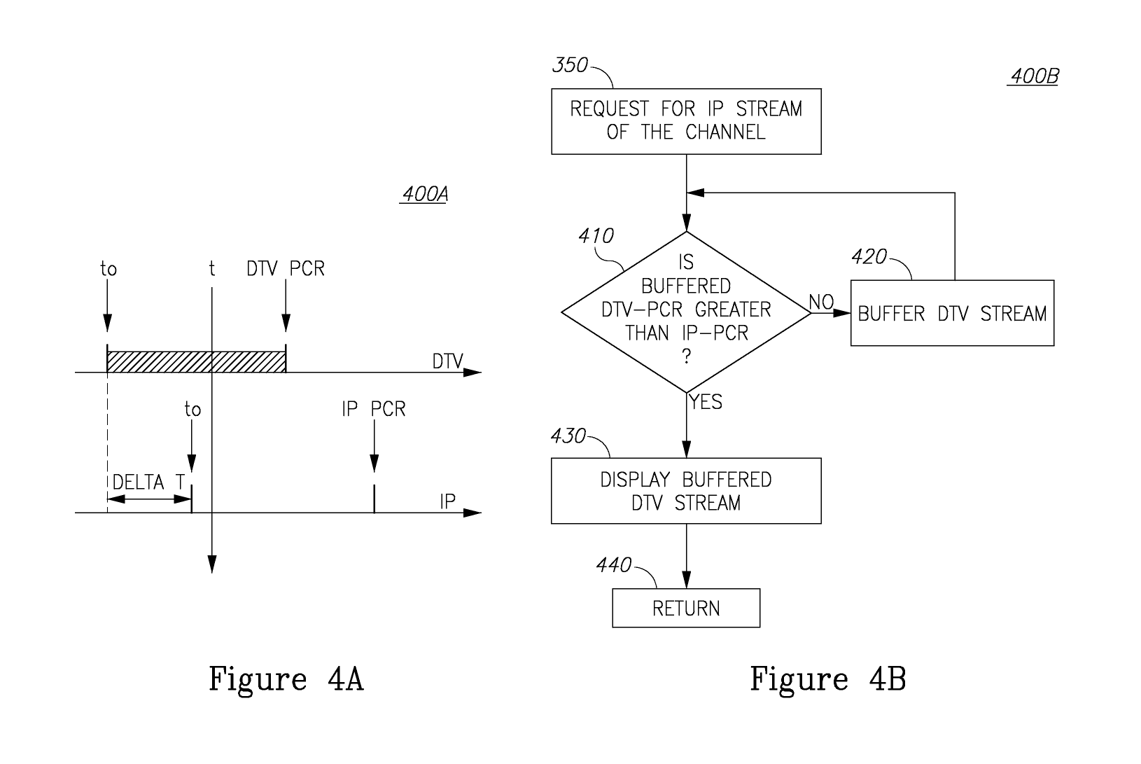

FIG. 4A is a timeline diagram illustrating the DTV stream (upper axis) and the IP stream (lower axis). As can be seen, the IP stream lags behind the DTV channel and at time slot t, the DTV channel is ahead of the IP channel. In case switching from DTV to IP channel is required, the next PCT point is checked and in case the IP-PCR is more remote than the DTV-PCR, the DTV is being buffered and displayed prior to the IP channel. In a case switching from IP to DTV is required, due to the lag, data loss is inevitable and the video pops forward.

FIG. 4B is a flowchart illustrating the switch to DTV from IP channel upon a request for IP stream 350. The buffered DTV is checked for PCR indicator vs. the PCR indicator of the IP stream 410. If DTV-PCR is not more remote than IP-PCR, the DTV stream is further buffered 420. In case the buffer is sufficient, the content is displayed over the display 430 and the procedure returns.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method comprising:
broadcasting a stream of a user-requested content over a digital television (DTV) channel;
monitoring at least one qualitative criterion of the stream broadcasted over the DTV channel;
in case that the monitored qualitative criterion is below a predefined threshold, switching said user to an Internet protocol (IP) channel that corresponds to same stream of said DTV channel; and
in a case that after switching to the IP channel, the monitored qualitative criterion becomes equal to or above said predefined threshold, switching back said user to said DTV channel,
wherein the switching back from the IP channel to the DTV channel comprises buffering the stream of the DTV channel through the IP channel so as to preserve continuity of the stream received by the user.

2. The method according to claim 1, wherein the DTV channel is associated with a digital terrestrial television system or a satellite transmission system.

3. The method according to claim 1, wherein the monitoring of the at least one qualitative criterion of the stream comprises monitoring the received signal of the broadcasted stream.

4. The method according to claim 1, wherein the monitoring of the at least one qualitative criterion of the stream comprises monitoring the quality of the video displayed to the user.

5. The method according to claim 1, wherein the switching of the user to an internet protocol (IP) channel is carried out by providing switching data for matching between a source of the DTV channel and a source of the IP channel.

6. The method according to claim 5, wherein the switching data is provided form a remote location independent of the DTV source and the IP source.

7. The method according to claim 1, wherein the switching back from the IP channel to the DTV channel comprises writing incoming content from the DTV channel into a cache while playing the steam from the IP channel until the stream reaches a program clock reference (PCR) already stored at said cache.

8. The method according to claim 1, wherein the switching to an Internet protocol (IP) channel further comprises checking if a buffer time recorded by a buffer of the IP channel is equal or greater than a low reception time in which the monitored qualitative criterion is below a predefined threshold.

9. The method according to claim 8, wherein in a case that buffer time is equal or greater than the low reception time, displaying a buffering image to the user for a time that is a difference between the buffer time and the low reception time.

10. A system comprising:
a digital television (DTV) source configured to broadcast a stream of a user-requested content over a DTV channel; and
a set top box configured to monitor at least one qualitative criterion of the stream broadcasted over the DTV channel,
wherein in case that the monitored qualitative criterion is below a predefined threshold, the set top box is configured to switch said user to an Internet protocol (IP) channel that corresponds to same stream of said DTV channel,
wherein in a case that after switching to the IP channel, the monitored qualitative criterion becomes equal to or above said predefined threshold, the set top box is configured to switch switching back said user to said DTV channel, and
wherein the switching back from the IP channel to the DTV channel comprises buffering the stream of the DTV channel through the IP channel so as to preserve continuity of the stream received by the user.

11. The system according to claim 10, wherein the DTV channel is associated with a digital terrestrial television system.

12. The system according to claim 10, wherein the monitoring of the at least one qualitative criterion of the stream comprises monitoring the received signal of the broadcasted stream.

13. The system according to claim 10, wherein the monitoring of the at least one qualitative criterion of the stream comprises monitoring the quality of the video stream received form the broadcast.

14. The system according to claim 10, wherein the switching of the user to an internet protocol (IP) channel is carried out by providing switching data for matching between a source of the DTV channel and a source of the IP channel.

15. The system according to claim 14, wherein the switching data is provided form a remote location independent of the DTV source and the IP source.

16. The system according to claim 10, wherein the switching back from the IP channel to the DTV channel comprises writing incoming content from the DTV channel into a cache while playing the steam from the IP channel until the stream reaches a program clock reference (PCR) already stored at said cache.

17. The system according to claim 10, wherein the switching to an Internet protocol (IP) channel further comprises checking if a buffer time recorded by a buffer of the IP channel is equal or greater than a low reception time in which the monitored qualitative criterion is below a predefined threshold.

18. The system according to claim 17, wherein in a case that buffer time is equal or greater than the low reception time, displaying a buffering image to the user for a time that is a difference between the buffer time and the low reception time.
